(19) United States
(12) Patent Application Publication
(10) Pub. No.: US 2009/0210861 A1
(43) Pub. Date: Aug. 20, 2009

(54) DITA DOCLET TOOL AND METHOD FOR EXTRACTING AND ANALYZING API DOCUMENTATION

(76) Inventor: Mariana Alupului, Medallion Drive, NC (US)

Correspondence Address: PATENTEC, 2001 JEFFERSON DAVIS HWY #301, ARLINGTON, VA, 22202, US

(21) Appl. No.: 12/034,618

(22) Filed: Feb. 20, 2008

(51) Int. Cl. G06F 9/44

(52) U.S. Cl. 717/123

(57) ABSTRACT

A software tool and method for extracting embedded source code documentation into an XML-based file, and then further processing the XML-based file to identify documentation errors corresponding to missing tagging and descriptions for classes, interfaces, methods, parameters, etc. Once the errors are identified, missing tags are filled in, and additional comment tags are created within the XML-based file, identifying the error and presenting possible recommendations for fixing it. The error information may further be highlighted to enhance its visual appearance.

### BACKGROUND OF THE INVENTION

1. Field of the Invention

The present invention relates generally to automated development tools for facilitating documentation of source code. More particularly, the present invention relates to a software tool and method for examining Java API source code, extracting the embedded documentation, and generating Darwin Information Typing Architecture (DITA) files that contain corrected documentation and comment tags for the missing tags or documentation.

2. Description of the Related Art

An Application Programming Interface (API) contains the procedure calls which enable software running on a computer to access resources provided by the operating system or by other comprehensive software packages. In order for new software to be properly written for the computer, a software developer who creates the software must have full knowledge of the exact syntax and method for accessing the procedures belonging to the API. This knowledge is presented in the API Documentation, a common example of which is the Java API Reference.

Because computer software and operating systems are constantly evolving, it is frequently necessary to update the software and therefore also the API documentation associated with it, because if the API source code were to be modified without the corresponding API documentation, then software written for the API would not function properly. One convenient way to maintain synchronization between the API source code and its documentation, as taught in U.S. Pat. No. 4,860,203 to Corrigan et al, the contents of which is incorporated herein by reference, is to embed documentation information about each procedure within the source code at a location nearby to the procedure. Then, upon subsequent editing of the procedure code, the documentation information that is proximate therewith may also be edited simultaneously. In addition, an updated API documentation may be automatically obtained from the source code by extracting the embedded documentation information, reformatting the text, and placing it in a separate API documentation file.

An example of this process is provided by the JAVADOC tool, created by Sun Microsystems for use with the JAVA API. A description of this tool and the format for embedded documentation information may be found in the webpage “How to Write Doc Comments for the JAVADOC Tool” located at the URL: http://java.sun.com/j2se/javadoc/writingdoccomments/index.html#exampleresult, whose contents are incorporated herein by reference. In FIG. 1, the routine getImage having steps 101 is shown preceded by its embedded documentation 102. Included within the documentation are the two parameters URL and name, the returned value Image and the “see also” link IMAGE. This embedded documentation may then be extracted using the automated JAVADOC tool, which reformats the information into HTML format as shown in FIG. 2.

In order for the automatic documentation extraction to work effectively, the embedded documentation must be written according to strict guidelines; otherwise, when the embedded documentation is extracted by the extraction tool, it may not process properly, or the resulting API documentation may be incomplete. To help ensure that the embedded documentation is properly written, JAVADOC also includes a DOCCHECK tool which examines the embedded documentation and generates output in HTML format indicating any errors that have been discovered. A description of the DOCCHECK tool and an example of the errors it is capable of discovering may be found at the following webpages, the contents of which are incorporated herein by reference:
http://java.sun.com/j2se/javadoc/doccheck/docs/DocCheck.html
http://java.sun.com/j2se/javadoc/doccheck/docs/DocCheckErrors.html

While the JAVADOC and DOCCHECK utilities provide a useful implementation for facilitating the extraction and identification of errors of documentation embedded in source code, the output created by these utilities is not in a format that is directly useable by certain software which rely on the Darwin Information Typing Architecture (DITA) format, which is an XML-based architecture for delivering technical information. In addition, tools such as DOCCHECK that check embedded documentation errors, examine the source code directly, rather than examining the formatted output of the documentation extraction tool. Further, while these documentation checking tools provide output listing the located errors, they do not provide automated correction of the documentation files.

### SUMMARY OF THE INVENTION

Therefore, the present invention provides a method and tool for extracting embedded source code documentation into an XML-based file, and then further processing the XML-based file to identify documentation errors corresponding to missing tagging and descriptions for classes, interfaces, methods, parameters, etc. Once the errors are identified, missing tags are filled in, and additional comment tags are created within the XML-based file, identifying the error and presenting possible recommendations for fixing it. The error information may be further highlighted with color to enhance its visual appearance.

### BRIEF DESCRIPTION OF THE DRAWINGS

While the extent of the invention is limited only by the scope of the appended claims, the principles of the present invention and further objectives and advantages thereof may best be understood by a preferred embodiment and mode of use which is set forth in the following detailed description and accompanying drawings, wherein:

FIG. 1 is an example of the source code for an API procedure with embedded documentation;

FIG. 2 shows the same documentation after formatting into HTML by an existing extraction tool;

FIG. 3 is a flowchart illustrating a process for analyzing the API source code documentation and checking it for errors using an existing documentation checking tool;

FIG. 4 shows a typical output from the documentation checking tool;

FIG. 5 is a flowchart illustrating the process according to a preferred embodiment of the present invention for analyzing the API source code documentation, generating the DITA data, examining the DITA data for documentation errors, and automatically correcting and suggesting recommendations for fixing the errors.

FIGS. 6A, 6B, and 6C show typical DITA screen displays exhibiting missing tags and <draft-comment> tags containing descriptions of the documentation errors for the CLASSES, METHODS and LINKS according to the present invention.

### DETAILED DESCRIPTION OF THE INVENTION

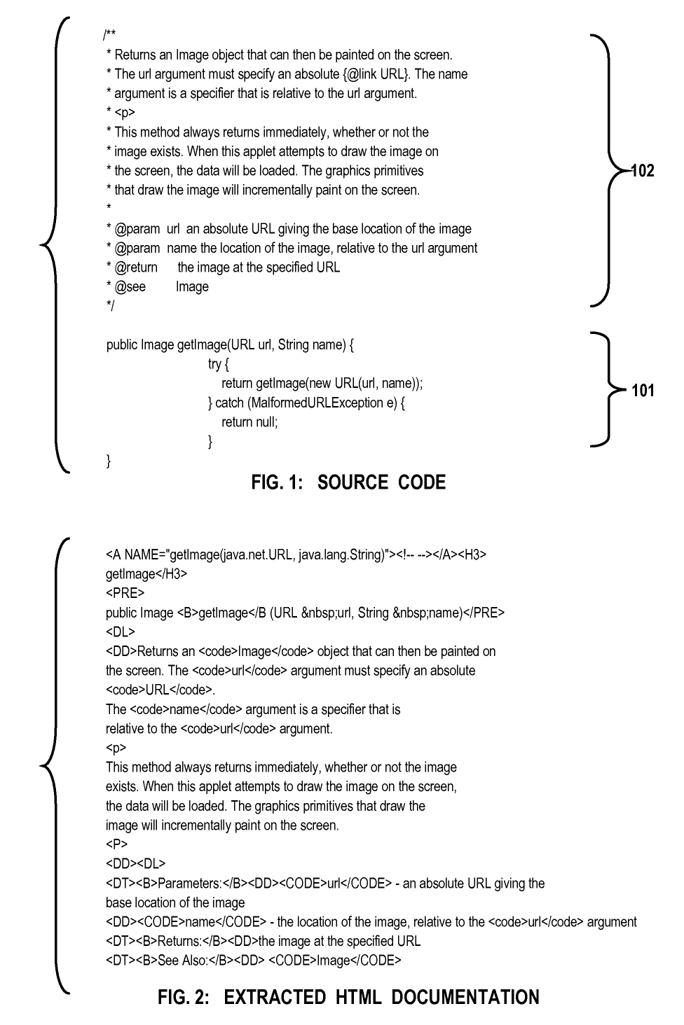

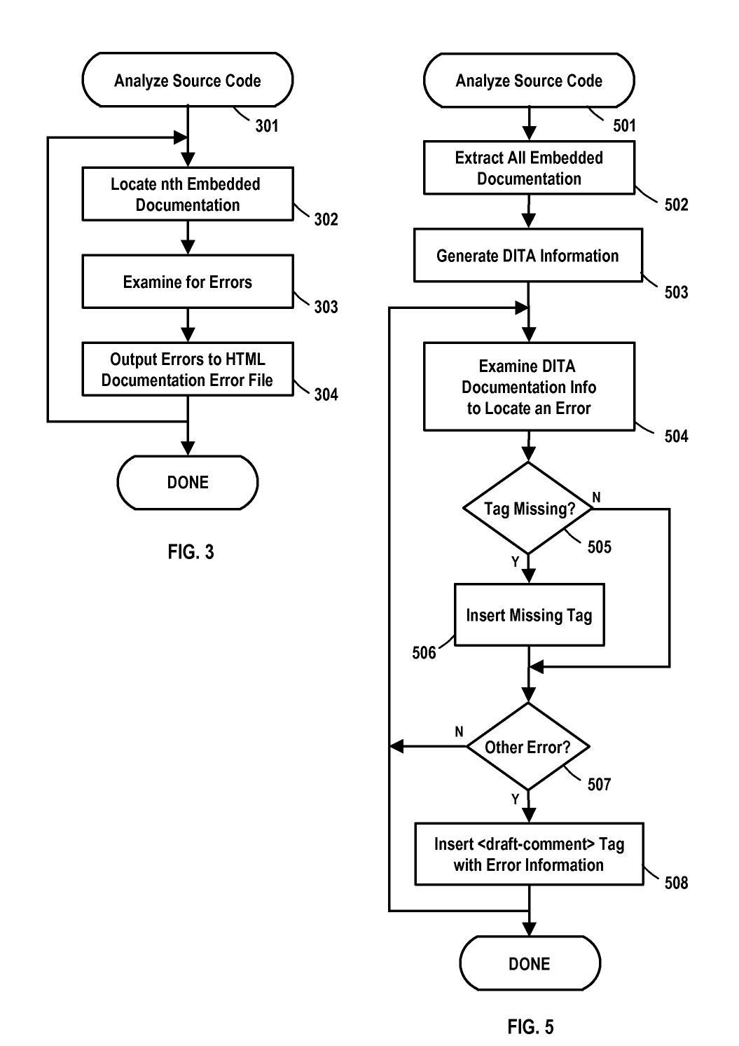

FIG. 3 shows in more detail a typical processing sequence used by prior documentation checking tools such as DOCCHECK to identify embedded documentation errors. First, the current version of API source code is opened for analysis. Then, the source code is examined 302 to locate pieces of embedded documentation, such as the documentation associated with a procedure as shown in FIG. 1. The embedded documentation is then analyzed to try to find any errors. If any are located, they are output to the HTML output file.

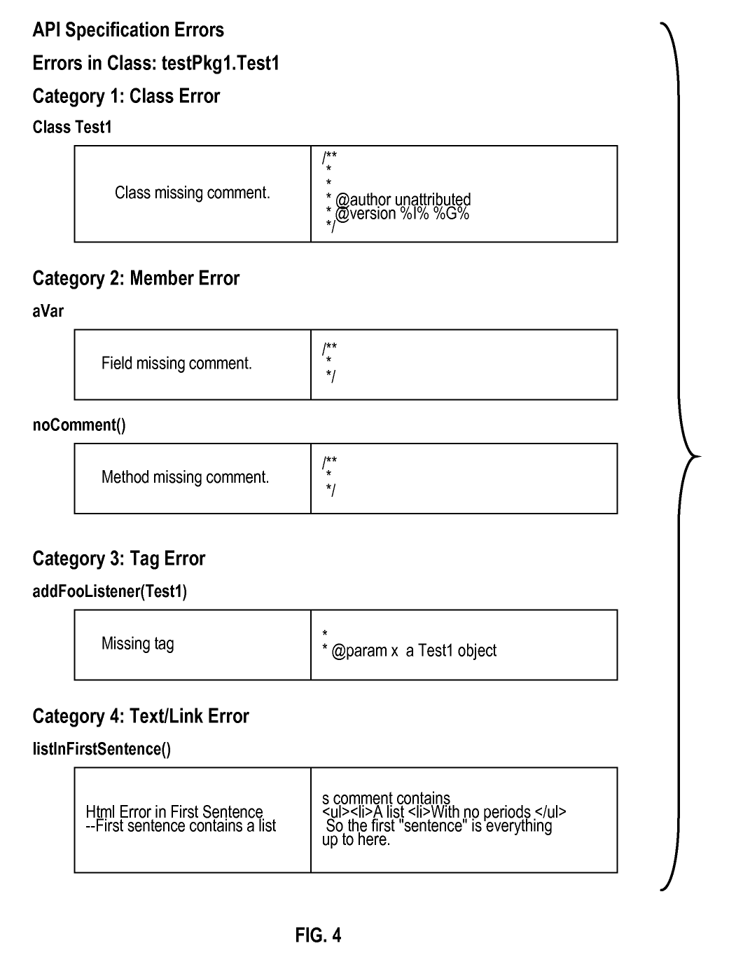

A typical error output file is shown in FIG. 4. The API is divided into categories CLASS, MEMBER, TAGS, AND TEXT/LINK. Within each category, the discovered errors are listed, along with the class, method, tag, etc. wherein the error appears and a brief clip of the source code showing where the error occurs. The displayed information facilitates the programmer in manually finding and correcting the errors.

While this output provides a useful method for discovering errors in API source code documentation, the present invention recognizes that in certain circumstances it is more useful to handle the API documentation in DITA format. Once converted to this format, it is easy to examine the data for possible documentation errors and to automatically correct some of the errors and include additional comment tags explaining the errors.

Accordingly, FIG. 5 shows a preferred processing sequence of the present invention for carrying out this procedure. In steps 501, 502, and 503, a DITA docklet tool processes the source code to extract all of the embedded documentation into a single DITA file, which may be retained in operating memory, or placed in external storage. Then, because of the hierarchical XML-based structure of the DITA format, the DITA tool may then effectively analyze the various classes, methods, tags, links, etc. to determine if there are any documentation errors in step 504. If the DITA tool discovers that a tag is missing, the tag is inserted directly into the DITA file 505, 506. A missing tag or any other error, such as missing additional documentation, will cause the DITA tool to insert an additional “draft-comment” tag in the DITA file, which includes information about the error 505. This error comment is highlighted with coloring to make it stand out against the other visible elements in the DITA listing.

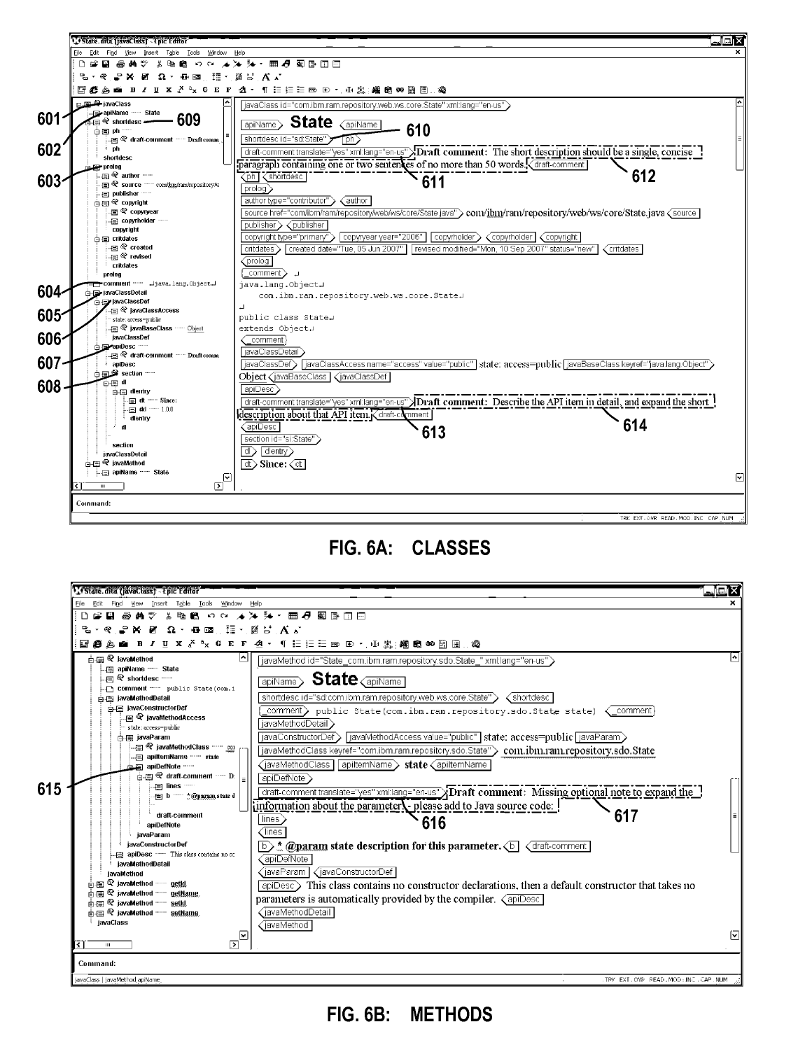

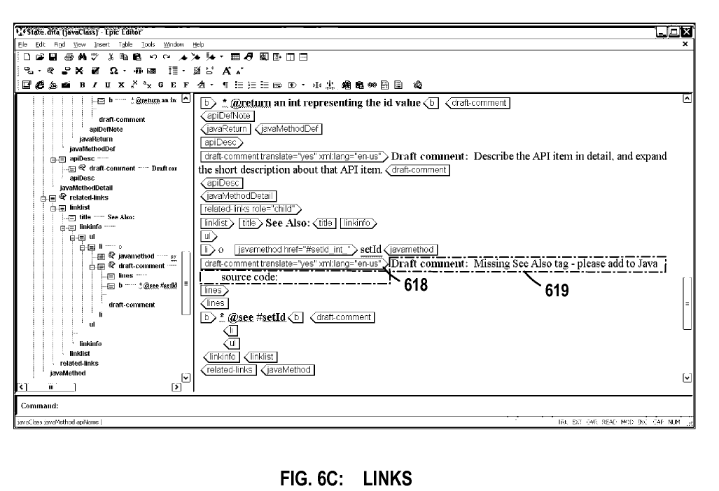

An example of the DITA listing with highlighted error information is shown in FIGS. 6A, 6B, and 6C for the JAVA CLASSES, METHODS, and LINKS, respectively. Initially, the DITA tool examines the API source code, and extracts the embedded documentation. For example, the DITA tool extracts the following JAVA Class hierarchy:

| | |
|---|---|
| JAVA CLASS | 601 |
| apiName | 602 |
| prolog | 603 |
| comment | 604 |
| javaClassDetail | 605 |
| javaClassDef | 606 |
| apiDesc | 607 |
| section | 608 |
| . . . | |

After completing extraction of all of the embedded source documentation, the DITA tool then searches the DITA information for missing tagging, parameters or methods, and suggests possible solutions. For example, after examining the JavaCLASS information, the DITA tool determines that the short description tag is missing, and inserts the <shortdesc> tag 609, 610 and the following XML <draft-comment> tag 612 in the DITA:
<shortdesc id=“sd:State”><ph>
<draft-comment translate=“yes” xml:lang=“en-us”> The short description should be a single, concise paragraph containing one or two sentences of no more than 50 words.</draft-comment>
</ph></shortdesc>

The DITA tool then discovers that the apiDesc tag 607 is present, but missing information. So, it inserts the following XML <draft-comment> tag 613 and associated information 614 within the apiDesc tag:
<draft-comment translate=“yes” xml:lang=“en-us”> Describe the API item in detail, and expand the short description about that API item.
</draft-comment>

After completing the Java CLASSES, the DITA tool then searches the Java METHODS for errors, and discovers that the apiDefNote is missing, so it inserts the <apiDefNote> tag 615 and the corresponding <draft-comment> tag 616 and associated information 617 as follows:

<apiDefNote>
<draft-comment translate=“yes” xml:lang=“en-us”> Missing
optional note to expand the information about the parameter: - please add
to Java source code:
<lines>
</lines>
<b>* @param state description for this parameter.</b> </draft-comment>
</apiDefNote>

In a similar fashion, the DITA tool searches the Java LINKS, identifies the missing links and inserts the XML code 618, 619:

<related-links role=“child”>
<linklist><title>See Also:</title>
<linkinfo> <ul><li>
<javamethod href=“#setId_int_”>setId</javamethod>
<draft-comment translate=“yes” xml:lang=“en-us”> Missing See Also
tag - please add to Java source code:
<lines></lines><b>*@see #setId</b> </draft-comment>
</li></ul> </linkinfo></linklist>
</related-links>

It can be seen from this simple example, that the DITA tool not only provides information that describes the documentation errors, but also corrects the DITA when necessary, by inserting missing tags.

In a preferred implementation, the DITA tool analyzes the following DITA elements, inserting the missing tags and providing comments and suggestions in <draft-comment> tags, in a similar fashion to the simple case described above:

CLASSES/INTERFACES:

| | |
|---|---|
| short descriptions | shortdesc |
| detailed descriptions | apiDesc |

METHODS/CONSTRUCTORS/FIELDS:

| | |
|---|---|
| short descriptions | shortdesc |
| detailed descriptions | apiDesc tag |
| parameters | @param |
| exceptions | @throws |
| return values | @return |

LINKS

| | |
|---|---|
| links to related classes, | |
| interfaces, packages, etc | @see |

In addition, the DITA tool automatically generates the package DITA (XML) files if the package overview HTML files are missing. In summary, wherever the DITA tool identifies missing elements, it attempts to re-create them and to generate draft-comments explaining the errors and suggesting the proper way to correct them. The DITA tool provides the author with a visual representation of what is missing and where they can enter the missing information directly in DITA Java API files and/or the source code to complete the Java API reference documentation.

The foregoing description of the invention has been provided for the purpose of illustrating the basic principles of the invention, and is not intended to be exhaustive or limiting of all possible variations of the invention that will be readily evident to those of ordinary skill in the art, in the light of the teachings found herein. Accordingly, the invention should be limited only by the spirit and scope of the claims appended herewith.

1. A computer-implemented method for generating API documentation from an API source code file and correcting and indicating documentation errors, comprising:
extracting embedded documentation information from said API source code file and generating an XML-based file containing a hierarchy of elements associated with said embedded documentation information;
analyzing said XML-based file, by traversing through said hierarchy of elements to locate any elements that are missing or that have documentation errors;
in the event said step of analyzing said XML-based file determines that an element is missing, inserting a tag in said XML-based file corresponding to said missing element and inserting a comment tag in said XML-based file identifying said missing element and including possible recommendations for fixing said missing element; and
in the event said step of analyzing said XML-based file determines that an element is present but contains missing or erroneous data, inserting a comment tag in said XML-based file identifying said missing or erroneous data and including possible recommendations for fixing said missing or erroneous data.
